(19) United States
(12) Patent Application Publication
(10) Pub. No.: US 2026/0141488 A1
(43) Pub. Date: May 21, 2026

(54) IMAGE PRE-PROCESSING FOR IMAGES GENERATED USING GENERATIVE AI

(71) Applicant: eBay Inc., San Jose, CA (US)

(72) Inventor: Denis Bekman, Kirkland, WA (US)

(21) Appl. No.: 18/954,027

(22) Filed: Nov. 20, 2024

(51) Int. Cl. G06T 5/60; G06T 5/50; G06T 11/40

(52) U.S. Cl. CPC G06T 5/60; G06T 5/50; G06T 11/40; G06T 2207/20092; G06T 2207/20221

(57) ABSTRACT

Systems and methods are directed to pre-processing images and triggering generation of images having natural backgrounds. The imaging system accesses a source image of an item and isolates the item by removing a background from the source image. An item category of the item is identified using an image classification model. Based on the item category, additional information regarding the item are identified including a typical orientation. The imaging system generates a prompt that includes at least some of the additional information and instructions to generate images having a natural background. The imaging system also generates a guidance image that is a combination of the source image with the background removed and a suggested background. Using the prompt and the guidance image, an artificial intelligence (AI) model is triggered to generate one or more images of the item having the natural background and a shadow of the item.

### TECHNICAL FIELD

The subject matter disclosed herein generally relates to image processing. Specifically, the present disclosure addresses systems and methods for pre-processing images, generating informative prompts, and triggering generation of images with natural backgrounds using generative artificial intelligence.

### BACKGROUND

Conventionally, a majority of existing text-to-image models are primarily developed to create artistic images. These models are not typically intended for generating images with natural looking backgrounds.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a diagram illustrating an example network environment suitable for image pre-processing for images and generating images using generative artificial intelligence (AI), according to example embodiments.

FIG. 2 is a diagram illustrating components of the imaging system, according to example embodiments.

FIG. 3A-FIG. 3K are example user interfaces displayed on a mobile device for generating images with natural backgrounds using generative AI, according to example embodiments.

FIG. 3L illustrates an example generated image that does not appear in a natural background.

FIG. 4 is a flowchart illustrating operations of a method for generating images with natural backgrounds using generative AI, according to example embodiments.

FIG. 5 is a flowchart illustrating operations of a method for generating a publication using a generated image, according to example embodiments.

FIG. 6 is a flowchart illustrating operations of a method for generating further images with natural backgrounds, according to example embodiments.

FIG. 7 is a flowchart illustrating operations of a method for editing the generated images, according to example embodiments.

FIG. 8 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Systems and methods are directed to pre-processing images and triggering generation of images with natural backgrounds. Thus, example embodiments address the technical problem of generating images having a background that appears natural to items in the generated images. In order to appear natural, each image includes a shadow of an item on a surface of the generated image. In various embodiments, an imaging system accesses a source image of an item and isolates the item by removing a background from the source image. An item category of the item is then identified using an image classification model. For example, the classification model can be an open-source model such as ImageNet, EfficienNet, or YOLO model. Alternatively, the classification model can be a proprietary model of associated with the system. Based on the item category, additional information regarding the item are identified that can include, for example, a relative size, a typical orientation or positioning of the item, typical environments, suggested lighting effects, and/or suggested backgrounds.

The imaging system generates a prompt using the additional information that instructs an artificial intelligence (AI) model or system to generate images having a natural background. The natural background comprises a background that appears natural to the item as if the generated image was a photograph of the item in an environment that contains the background. This can include providing a shadow of the item in the generated image. The imaging system can also generate a guidance image that is a combination of the source image with the background removed and a suggested background. The suggested background can be a background category (e.g., an outside scene, a surface, a studio scene) or an actual background (e.g., a wood tabletop with a blurred kitchen backdrop). In some cases, the source image with the background removed is placed on top of the suggested background to generate the guidance image. The guidance image provides a starting point from which the generative AI model or system can deviate in generating different versions of the image. The prompt along with the guidance image are then used to trigger the artificial intelligence (AI) model or system to generate a first set of one or more images having a natural background and an appropriate shadow of the item. The first set of one or more generated images can be displayed on a client device.

Further processing can be performed after the generation of the first set of generated images. In some embodiments, further images can be generated. In some cases, one of the generated images can be selected and further images are generated using the selected generated image as the new guidance image. In other embodiments, one of the generated images can be selected and shown in a preview and/or incorporated into a publication. In still further embodiments, the generated images can be edited (e.g., a background element changed, a shadow altered) or a different suggested background selected, which triggers generation of new images.

Post-processing can also be performed. The post-processing includes isolating the shadow in one of the generated images and saving the shadow for later use. For example, if future images for a similar item are to be generated and the background is not of importance, the shadow can be reused instead of having a generative AI system generate the images. For example, an image of an item can be isolated and placed on a generic off-white studio background and the shadow added. This reuse of the shadow results in conservation of bandwidth, time, and/or computing resources that would be required in using generative AI.

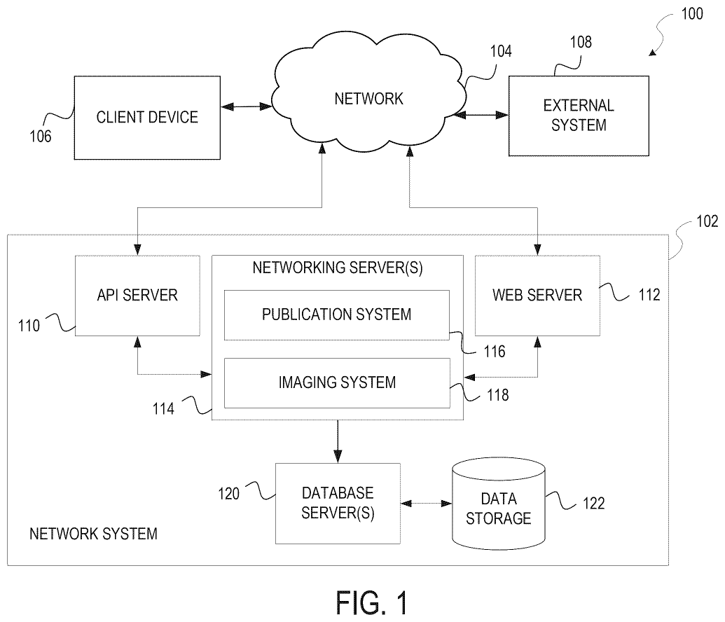

FIG. 1 is a diagram illustrating an example network environment 100 suitable for image pre-processing and generating images using generative artificial intelligence (AI), according to example embodiments. A network system 102 provides server-side functionality via a communication network 104 (e.g., the Internet, wireless network, cellular network, or a Wide Area Network (WAN)) to a client device 106. The network environment 100 is configured to receive source images and instructions from the client device 106, pre-process the source images, and generate generative AI images with natural backgrounds of items in the pre-processed source images, as will be discussed in more detail below.

In various cases, the client device 106 is a device associated with a user of the network system 102 that wants to incorporate an image that they have taken into a publication generated by the network system 102. Because the image may not appear professional or otherwise has an unattractive background, the user uses example embodiments to improve a background of the image before incorporating into the publication. For example, the user can be publishing a publication (e.g., article) that contains images. In another example, the user can be a seller that wants to generate a publication (e.g., a listing) to be published to an online marketplace.

The client device 106 comprises one or more applications (not shown) that communicate with the network system 102 for added functionality. In one embodiment, the applications comprise a communication component that exchanges data with the network system 102. For example, the application can be a local version of an application or component of the network system 102. The application may be provided by the network system 102 and/or downloaded to the client device 106.

In example embodiments, the client device 106 interfaces with the network system 102 via a connection with the network 104. Depending on the form of the client device 106, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

The client device 106 may comprise, but is not limited to, a smartphone, tablet, laptop, multi-processor systems, microprocessor-based or programmable consumer electronics, game consoles, or any other communication device that can access the network system 102. Additionally, the client device 106 comprises a display component (not shown) to display information (e.g., in the form of user interfaces) as will be discussed in more detail below. The client device 106 can be operated by a human user and/or a machine user.

Turning specifically to the network system 102, an application programing interface (API) server 110 and a web server 112 are coupled to and provide programmatic and web interfaces respectively to one or more networking servers 114. The networking server(s) 114 host various systems including a publication system 116 and an imaging system 118, each of which comprises a plurality of components and each of which can be embodied as hardware, software, firmware, or any combination thereof. The networking server(s) 114 are, in turn, coupled to one or more database servers 120 that facilitate access to one or more storage repositories or data storage 122. The data storage 122 is a storage device storing, for example, user accounts including user profiles of users of the network system 102 and can also store images associated with users to their user accounts.

The publication system 116 is configured to manage publications (e.g., articles, listings of available goods or services) and transactions at the network system 102 including generating and publishing the publications, conducting searches for publications, and/or maintaining user accounts. The publication system 116 may comprise an account component that maintains and updates data associated with each user account by storing data to the data storage 122. In example embodiments, the user accounts can include images and publications associated with users of the network system 102.

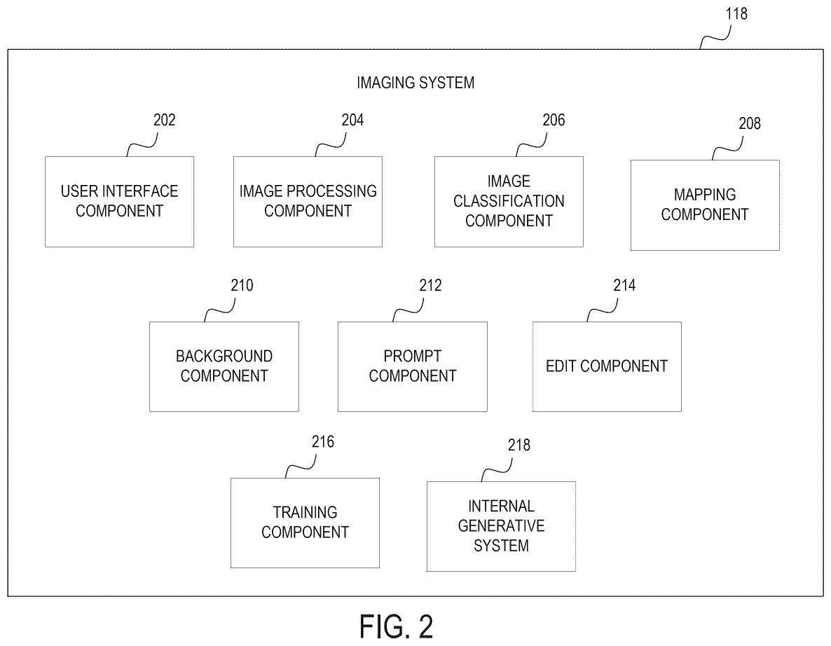

The imaging system 118 is configured to pre-process source images and generate informative prompts for triggering generation of images with natural backgrounds using generative artificial intelligence. The imaging system 118 will be discussed in more detail in connection with FIG. 2 below.

The environment 100 can also comprise an external system 108. The external system 108 can be a third-party system that performs data operations or processing for the network system 102. For example, the external system 108 can comprise a large language model (LLM) or generative artificial intelligence (AI) system that processes data on behalf of the network system 102. The LLM is a trained model configured to generate text and perform natural language processing tasks. Specifically, the LLM can generate additional information regarding an item/object in a source image and/or can generate a prompt to trigger generation of images. The generative AI system can be prompted to generate the images having specific, natural backgrounds and including a shadow.

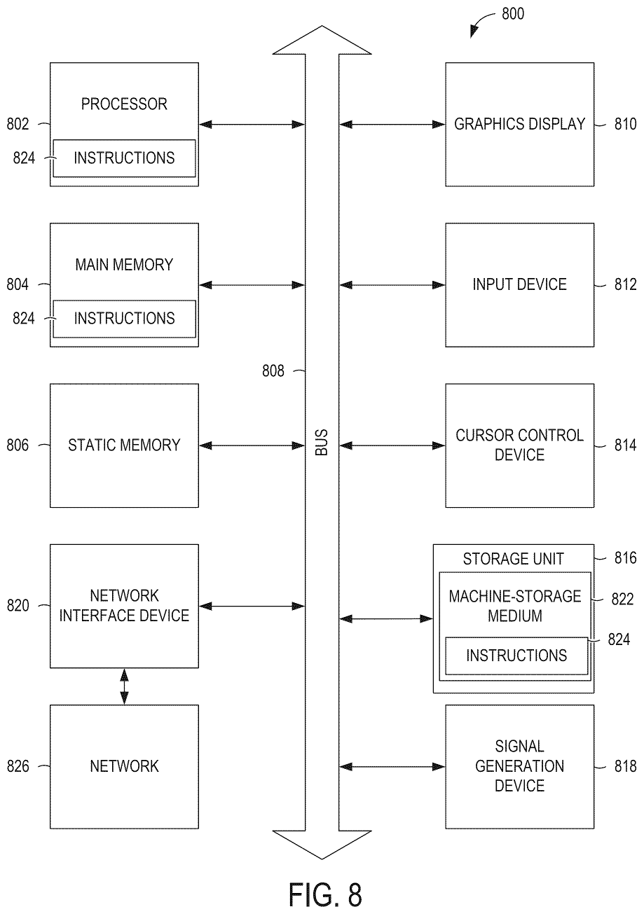

Any of the systems, data storage, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 8, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one system may, in alternative examples, be embodied in a different system. For example, any of the functionalities discusses above with respect to the imaging system 118 may be embodied within the client device 106 or publication system 116. Additionally, any number of client devices 106 and data storage 122 may be embodied within the network environment 100. While only a single network system 102 is shown, alternatively, more than one network system 102 can be included (e.g., localized to a particular region).

FIG. 2 is a diagram illustrating components of the imaging system 118, according to example embodiments. The imaging system 118 is configured to pre-process images and generate informative prompts for triggering generation of images with natural backgrounds using generative artificial intelligence. The generated images can be edited or backgrounds changed by the imaging system 118. The imaging system 118 can also post-process the generated images such that, for example shadows can be reused. To enable these operations, the imaging system 118 comprises at least a user interface component 202, an image processing component 204, an image classification component 206, a mapping component 208, a background component 210, a prompt component 212, an edit component 214, a training component 216, and an internal generative system 218, which are communicatively coupled together (e.g., via a bus). It is noted that some of the components of the imaging system 118 can be located elsewhere in the network system 102 or network environment 100 and be communicatively coupled to the imaging system 118.

The user interface component 202 is configured to manage user interfaces that are displayed on the client device 106. The user interface component 202 can receive inputs via the user interface from the client device 106. For example, the user interface component 202 can receive an indication of a source image, a title for a publication, and/or additional information regarding an item in the source image. The user interface can also receive indications or instructions to perform further processing of generated images. For example, a user can indicate, via the user interface displayed on their client device 106, to generate the publication using a generated image, generate further images based on one of the generated images, edit a generated image, or isolate a shadow in a generated image. The user interface component 202 also generates and/or updates user interfaces to display the various generated images and further processing options.

The image processing component 204 is configured to pre-process the source image and remove a background of the source image. As such, the image processing component 204 accesses the source image (e.g., access from a data storage; receive from the client device 106) and performs image processing to isolate an item or object in the source image. Some example models that can be used to isolate the item include, for example, U2Net, Segment Anything Model (SAM), and Segment Anything Model 2 (SAM2). Once the item is isolated, the background is then removed from the source image by the image processing component 204. In some embodiments, the background is removed by transforming the source image with a vision model that creates a grey-scale mask, whereby white pixels identify the item and black pixels identify the background. In some cases, the image processing component 204 can also crop and scale an image of the item and/or enhance contrast.

In some embodiments, the image processing component 204 can also generate guidance images that are provided with the prompt to the generative AI system. A guidance image comprises the source image with the background removed combined with a suggested background. In some cases, the source image with the background removed is positioned on top of the suggested background to generate the guidance image.

The image processing component 204 is also configured to post-process one or more generated images. In example embodiments, the user can select a generated image and the image processing component 204 can perform image processing to isolate a shadow that has been included in the selected, generated images. In some embodiments, the isolated shadow can be stored and/or associated with an item category of the item in the generated images as part of the mapping information, discussed further below. The shadow can be reused in later generated images without having to use the generative AI system. By reusing the shadow and avoiding the use of the generative AI system, bandwidth, time, and computing resources can be conserved.

The image classification component 206 is configured to identify the item or object in the source image. In one embodiment, the image classification component 206 comprises a trained classification model. The source image (with or without the background removed) is applied to the classification model, which can identify at least an item category for the item in the source image (e.g., athletic shoes, jewelry). In some cases, the classification model can identify the item itself (e.g., Air Jordan sneakers, a pair of hoop earrings).

The mapping component 208 is configured to obtain additional information (also referred to as “mapping information”) for the item. In example embodiment, the mapping component 208 takes the item category identified by the image classification component 206 and looks up the item category in a mapping database. The mapping database comprises a mapping of each item category to the additional information. The additional information can include, for example, a relative size, a typical orientation of an item in the item category (e.g., general placement or positioning such as lying flat, upright, hanging), natural environment(s) for the item category, typical angle of view of the item (e.g., front view, top down view), and/or applicable lighting or lighting effects. In some cases, a post-processed shadow can be included as part of the mapping data for an item category.

In some cases, information can be inferred by the mapping component 208. For example, if the item is identified as a piece of jewelry, the mapping component 208 can assume that the angle of view will be top down and the size is small even if the mapping database does not include this information.

In some embodiments, the mapping database may indicate one or more suggested backgrounds (e.g., background categories or actual backgrounds) for the item category. For example, if the item is categorized as a vase, the additional information obtained from the mapping database can indicate that the item is typically positioned upright on its bottom surface (e.g., orientation), can have lighting coming from above at a 45 degree angle, is typically between 5-12″ (e.g., relative size), is typically in an indoor environment (e.g., natural environment), and/or can have a suggested background that includes a surface background category or an actual background that features a cherrywood tabletop with a blurred dining room backdrop.

In alternative embodiments, the mapping component 208 comprises or uses an LLM to determine the additional information. In some embodiments, the LLM can pre-generate the additional information for some item categories and store the pre-generated additional information in the mapping database. In other embodiments, a prompt is generated by the mapping component 208 based on the item category and any information the user may have provided with the source image to dynamically determine the additional information. For example, the information provided by the user can include a title for the publication. The prompt is then provided to the LLM (e.g., the external system 108 or internal generative system 216), which is prompted to identify the additional information. In some cases, the source image with the background removed can be provided with the prompt to the LLM. In some embodiments, the prompt can instruct the LLM to not only identify the additional information but use that additional information along with the source image with the background removed to generate a further prompt that triggers generation of the images by the generative AI system.

The background component 210 is configured to identify suggested backgrounds for the item. The suggested backgrounds can be a category or general scenery (e.g., outdoors, a surface) or be an actual background (e.g., kitchen countertop with blurred kitchen backdrop). In some cases, the suggested backgrounds can be curated for particular item categories (e.g., approved by designer or brand) to provide a branded look. In one embodiment, the suggested background can be obtained from the mapping information identified by the mapping component 208. In other embodiments, the suggested backgrounds are determined based on the environment information obtained from the mapping component 208. For example, if the item is a pair of hiking boots, the environment information can indicate outdoors. As such, the background component 210 determines corresponding suggested backgrounds that include an outdoor background category or actual outdoor backgrounds (e.g., hiking trail on side of mountain).

In some cases, the suggested backgrounds are backgrounds that are typically used for the item or item category or are used in publications that are selected the most by other users. For example, the suggested backgrounds were used in publications (e.g., item listings) that resulted in the most sales. In another example, other uses selected the suggested backgrounds the most in generating their images. In some embodiments, this feedback on the use of previously selected (suggested) backgrounds can be used to train a further model (e.g., a background selection model) that can identify suggested backgrounds for an item or item category. The suggested backgrounds identified by the model can be used in addition to any suggested backgrounds obtained via the mapping component 208 and/or be used to update the suggested backgrounds in the mapping database.

The prompt component 212 is configured to generate prompts to trigger the generative AI system to generate images with a natural background that includes an appropriate shadow. The prompt component 212 can include the identification of the item or item category, the additional information obtained from the mapping component 208, and instructions to generate images using the provided information and including a shadow. For example, the prompt can indicate that the item is a fishbowl that should be sitting (e.g., orientation) on top of a wooden counter (e.g., suggested background) with a light source coming from a top right (e.g., lighting effect). The more information that is known about the item, the more specific the prompt can be.

In some embodiments, the prompt can also include a parameter that indicates how much deviation from a guidance image (e.g., the source image with the background removed combined with a suggested background) the generative AI system can apply in generating the images. For example, the parameter (also referred to as “deviation parameter”) can be between 0 and 1. If the parameter is set it to 1, the generative AI system can ignore the guidance image completely. Conversely, if the parameter is set to 0, the generative AI system takes the guidance image and generates nothing new. Thus, this parameter is tuned (or is tunable) to certain values. For example, the parameter can be set between 0.9 and 0.6 depending on the item/item category and type of background the user wants to generate. For example, the parameter may be set tighter (e.g., 0.9) for a studio background and be more relaxed for an outdoor background. In some cases, the parameter can be obtained from the mapping data and/or can be refined based on feedback, as will be discussed further below.

The prompt can include instructions to include a shadow for the item in the source image. The shadow can be generated based on a presumed angle of light that will be positioned on the item. In some cases, the presumed angle can be obtained from the mapping data. In some embodiments, the shadow can be made more dramatic or less by tuning the above discussed parameter.

The prompt along with the guidance image (e.g., the source image with the background remove combined with the suggested background) is then used to trigger the generative AI system to generate the images. In some cases, the source image with the background remove is positioned over the suggested background to generate the guidance image.

In embodiments where the generative AI system is the external system 108, the imaging system 118 (e.g., the prompt component 212) receives the generated images via the network 104 and passes the generated image to the user interface component 202. Alternatively, if the generative AI system is the internal generative system 218, the generated images can be passed from the internal generative system 218 to the user interface component 202. The user interface component 202 then causes display of a user interface on the client device 106 that displays the generated images. Any number of generated images can be generated and displayed on the client device 106.

The user of the client device 106 can perform various operations given the displayed generated images. For example, the user can select one of the generated images and an option to trigger generation of additional images. When this option is selected, the prompt component 212 generates a further prompt with instruction to generate further images using the selected generated image as the new guidance image. In another example, the user can select one of the generated images to view a preview (e.g., a larger version of the image) of the selected image and/or incorporate the selected image into a publication. The user can also select an option to generate images using a different suggested background.

Further still, the user can select an option to edit a generated image. The edit component 214 is configured to identify edit options for the generated images. In various embodiments, the edit options are based on the current selected suggested background. Edit options can include, for example but not limited to, changing a material, changing a shadow, changing a surrounding, changing a mood, or changing a background color. Because not all edit options are applicable to the different background categories, the edit component 214 identifies the applicable edit options and provides those to the user interface component 202 for display.

The training component 216 is configured to train one or more models used by the imaging system 118. In one embodiment, the training component 216 trains the classification model. Accordingly, images of items and their corresponding classification information can be used as training data to train the classification model. In some cases, the classification information comprises an item category. In other cases, the classification information can comprise additional description regarding the item and can even identify the specific item, itself. Additionally, the training data can include publications generated by other users of the network system 102.

In other embodiments, the training component 216 trains the background selection model. The training data can include previously suggested backgrounds used in publications for each item category and feedback on use of the previously suggested backgrounds. The feedback can include previously suggested backgrounds that resulted in the most interaction (e.g., clicks, sales) or that were used the most for the corresponding item category.

In a further embodiment, the training component 216 trains one or more models of the internal generative system 218. For example, the training component 216 can train an LLM of the internal generative system 218 to identifying mapping information and/or generate an image prompt. In training the LLM to identify mapping information, the training component 216 can use training data comprising items, items images, descriptions (e.g., titles), and/or corresponding mapping information. In one instance, the LLM can be trained with the mapping information in the mapping database. In training the LLM to generate the image prompt, the training component 216 can use training data comprising items, item categories, mapping information, previously generated corresponding prompts, and/or results of previously generated corresponding prompts. The LLM can be fine-tuned (e.g., retrained) by running trials using different prompts, comparing the outcomes, and seeing what prompts produced the best results (e.g., more selections, more interactions).

In some cases, the training component 216 can machine learn and fine-tune the parameters used to control deviation from the guidance image by the generative AI model. The fine-tuning is based on feedback associated with previously generated images by the generative AI model. For instance, a plurality of generated images can be produced by the generative AI model over a certain parameter range. Feedback can then be obtained on the plurality of generated images (e.g., which particular images were interacted with more). Based on the feedback, the parameters can be adjusted for different item categories and/or types of backgrounds.

In some embodiments, the internal generative system 218 can comprise generative AI that generates the images. In one embodiment, the training component 216 can train a generative AI model to generate the images. In these cases, the training component 216 can use training data that includes, for example, various backgrounds, guidance images, deviation parameters, and generated images. The training data can also include information regarding which generated images are used and/or selected the most (e.g., for publication, most interacted with).

The internal generative system 218 is the internal equivalent of the external system 108. In some embodiments, the presence of the internal generative system 218 results in no need for the external system 108. Conversely, the imaging system 118 can use the external system 108 and there is no need for the internal generative system 218.

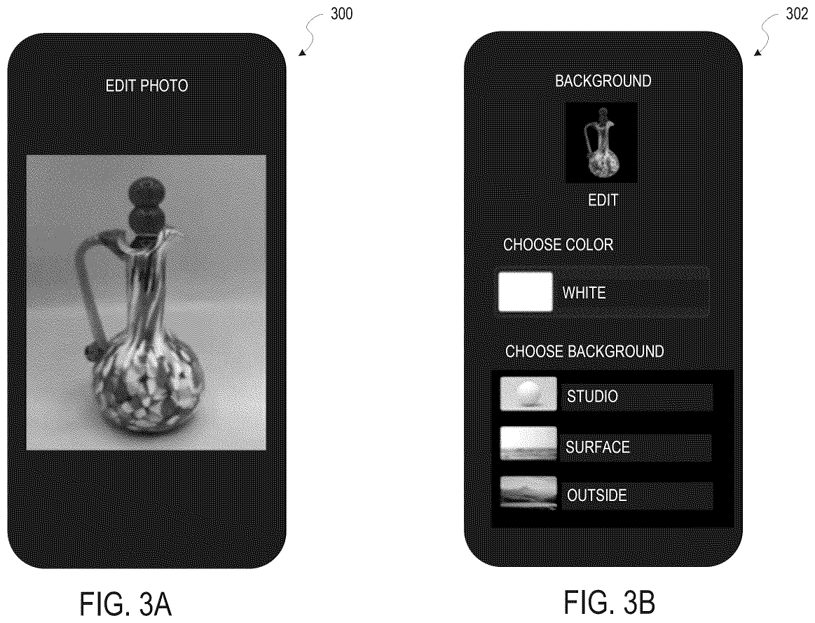

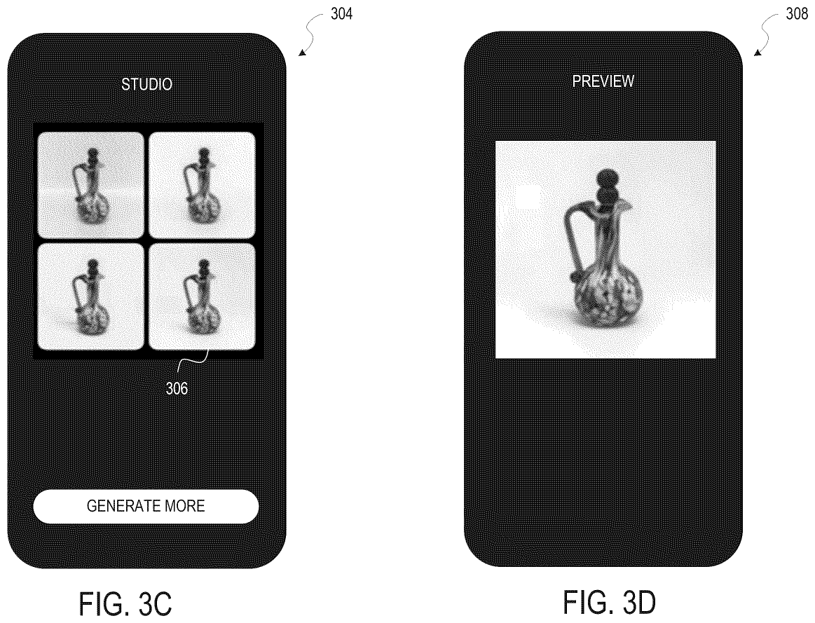

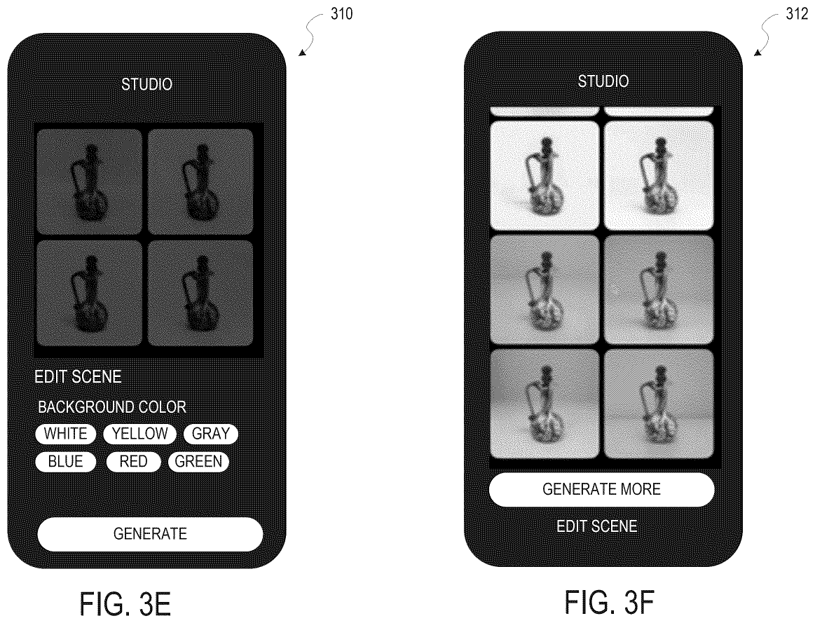

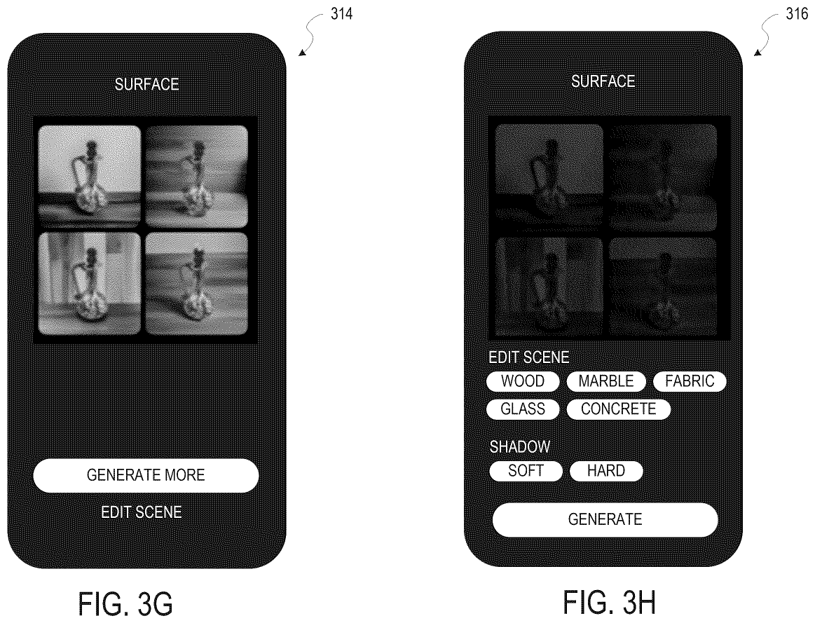

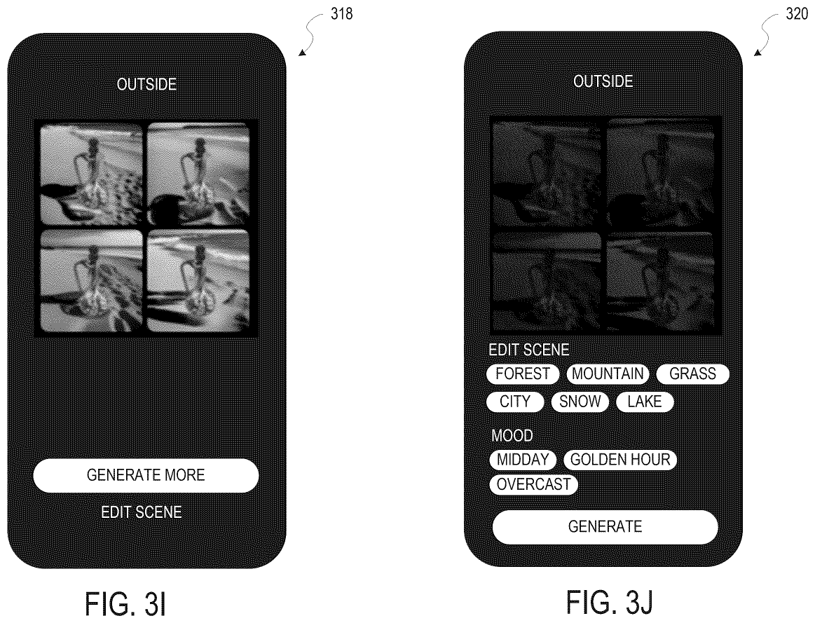

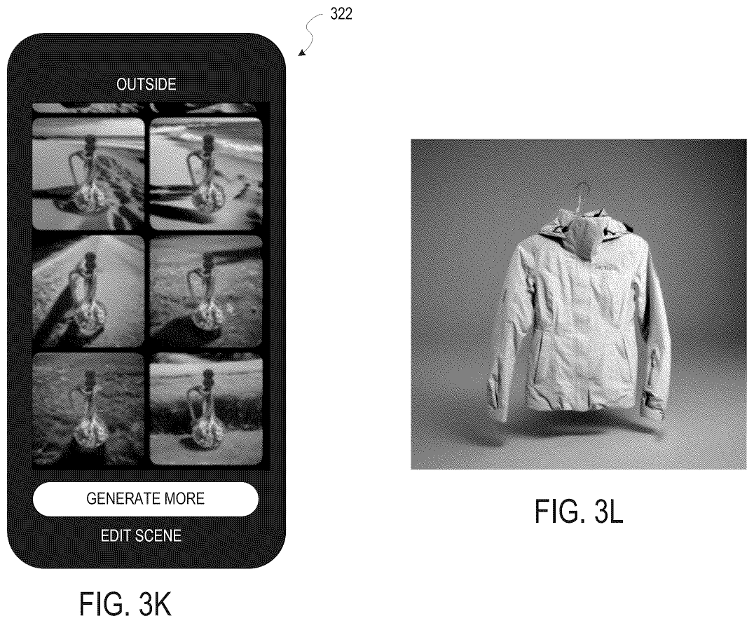

FIG. 3A-FIG. 3K are example user interfaces displayed on the client device 106 (e.g., a mobile device) for generating images with natural backgrounds using generative AI, according to example embodiments. In example embodiments, a user activates an application on their client device 106 to create a publication. Once the application is activated, the user can select a source image or capture an image using an image capture device (e.g., camera) of the client device 106 of an item that the user wants to use in the publication. FIG. 3A shows a user interface 300 in which the user has selected a source image of a water carafe.

Once the source image is selected, the imaging system 118 processes the source image. Specifically, the image processing component 204 processes the source image to remove the background from the source image. The image processing component 204 can also crop, scale, and/or enhance contrast. Additionally, the image classification component 206 applies the source image of the item to a classification model to identify the item or item category. Furthermore, the mapping component 208 identifies mapping or additional information regarding the item category, while the background component 210 can identify one or more suggested backgrounds for the item.

Referring now to FIG. 3B, a user interface 302 is updated to show an image of the item (e.g., source image with the background removed) in a top portion. Below the image of the item are a plurality of suggested backgrounds along with an option to select a color for a plain background (e.g., white). The plurality of suggested backgrounds include a studio category, a surface category, and an outside category. While background categories are shown in FIG. 3B, alterative embodiments can include one or more actual backgrounds instead of, or in addition to, the background categories.

Assuming the user selects (e.g., taps on) the studio background option, the prompt component 212 generates a prompt that will trigger generation of an image having a studio background. The prompt can include the additional information (e.g., oriented upright, typically front view, relative size of 30 cm, lighting effect from top right) obtained by the mapping component 208 and instructions to generate a natural looking image that includes a shadow. A guidance image can also be generated (e.g., by the image processing component 204) by combining the source image of the item with the background removed with a sample studio background. The prompt along with the guidance image are then transmitted to the generative AI system (e.g., the external system 108 or the internal generative system 216). The prompt triggers the generative AI system to generate images having a natural, studio background that includes a shadow.

FIG. 3C illustrates a user interface 304 is updated to show a plurality of generated images that are returned by the generative AI system. As illustrated, each of the generated images comprises a studio background which is an off-white, diffused background having a surface on which the item sits upright on. Each generated image also includes a shadow of the item shown on the surface. In the example of FIG. 3C, the shadows are each slightly different.

At a bottom of the user interface 304 is an option to generate more like images. Selection of one of the generated images and this option will trigger the generative AI system to generate more images using the selected generated image as the new guidance image.

The user can select one of the generated images in order to see a preview of the selected generated image in a larger size. For example, the generated image 306 shown on the bottom, right can be selected. FIG. 3D shows a user interface 308 updated to display a preview of the generated image 306. If the user is satisfied with the generated image 306, the user can select an option to incorporate the generated image 306 into a publication.

Alternatively, the user can edit the generated images. Referring now to FIG. 3E, the user has elected to edit the generated images. In response, the edit component 214 identifies the edit option(s) available for a studio background. In the present example, the edit options include changing a background color of the generated images. As such, a user interface 310 shows different color options that can be applied. In one example, the user selects the color yellow. A new prompt is then generated by the prompt component 212 that can include one or more of the previously generated images as a new guidance image and an indication to change the background color to yellow. An example user interface 312 with the result of the new prompt is shown in FIG. 3F. The changing of the color to yellow helps further distinguish a back surface (e.g., a wall) from the surface on which the item is sitting on. Here, the user can generate more images with the yellow studio background and/or edit the scene again (e.g., change the background color).

The user can also return, for example, to the user interface 302 of FIG. 3B to change a background or background category. For example, the user can select the surface category option. In response to selection of this option, a further prompt is generated with the additional information and instructions to generate images with a natural background and a shadow based on the guidance image. The further prompt along with the guidance image (e.g., source image with the background removed combined with a sample of a surface background) is used to trigger the generative AI system. The resulting generated images are displayed in a user interface 314 shown in FIG. 3G. The surface in the example of FIG. 3G is a wood surface on which the item is sitting. In some of the generated images, the wood surface is also shown behind the item as part of a wall. Each generated image includes a shadow of the item on the surface on which the item is sitting.

The user has an option to generate more images with the wood surface background and/or edit the scene. Editing the scene can include changing the material that is the surface and/or changing the shadow (e.g., include more or less shadow reflection), as determined by the edit component 214. While the initial material is wood, the user may want a different material. As such, the user can select an edit scene option at the bottom of the user interface 300. In response, a user interface 316 is updated to show different materials the user can select from.

FIG. 3H illustrates an example of the user interface 316 showing example edit options that are available for a surface background. As shown, material options include wood, marble, fabric, glass, and concrete. Additionally, the user interface 300 includes the option to soften (e.g., make lighter) or harden (e.g., make darker) the shadow. The different material options can be default or can be customize and/or learned for the item category based on previously used material options and positive feedback for those previously used material options (e.g., high interaction rate). The user can select one of the edit options and tap a generate icon to trigger the edit and cause a further set of images to be generated and displayed.

Furthermore, the user can return once again to the user interface 302 of FIG. 3B to change the background—this time selecting the outdoor category option. In response to selection of this option, a further prompt is generated that includes the additional information and instructions to generate images based on the additional information and a guidance image. The prompt along with the guidance image (e.g., the source image with the background removed combined with a sample of an outdoor background) is used to trigger the generative AI system. The resulting generated images are shown in a user interface 318 of FIG. 3I. The outdoor background in the example of FIG. 3I is a beach scene in which the item is sitting upright on sand. Each generated image includes a shadow of the item on the sand.

The user has the option to generate more images of the item on the beach or edit the scene. Here, editing the scene can include changing an outdoor element of the outdoor scene or changing a mood of the scene, as determined by the edit component 214. FIG. 3J shows a user interface 320 updated to display different outdoor element options including forest, mountain, grass, city, snow, and lake. The different mood options include midday, golden hour, and overcast. The selection of the mood option can change lighting in the background scene, which may have an effect on the shadow.

Assuming the user selects the grass outdoor element option, the prompt component 212 generates another prompt and sends the prompt with a new guidance image (e.g., the source image with the background removed and a sample of a grass outdoor background) to the generative AI system. In response, the generative AI system generates a plurality of images having a grass outdoor background that is added to the user interface 320 of FIG. 3I resulting in a user interface 322 as shown in FIG. 3K. The generated images each show the item sitting upright on a grass surface with a corresponding shadow.

To illustrate the item placement problem, FIG. 3L is an example generated image that does not appear in a natural background. As shown, an article of clothing (e.g., a jacket) appears to be standing on its own. This creates an unnatural appearance since it is not possible in the real world. To avoid this situation, example embodiments limit background generation for this item category to laying flat or hanging. For instance, the mapping information may indicate that the orientation is laying flat and/or hanging.

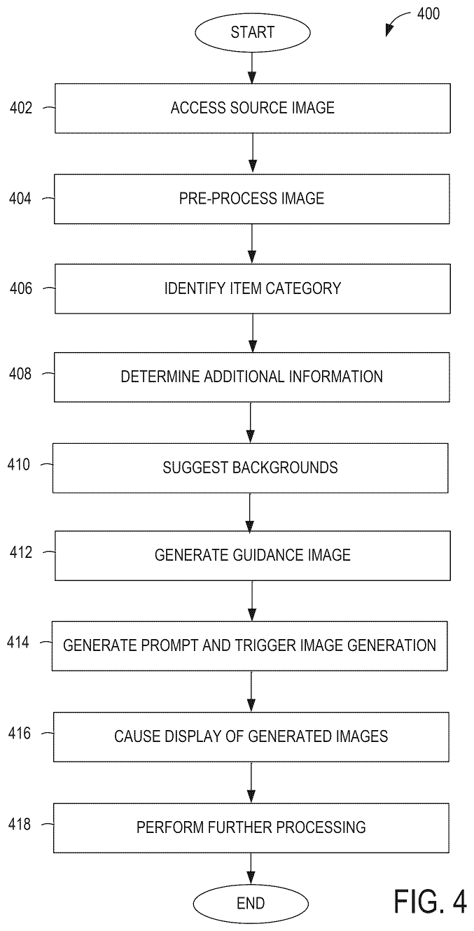

FIG. 4 is a flowchart illustrating operations of a method 400 for generating images with natural backgrounds using generative AI, according to example embodiments. Operations in the method 400 may be performed by the imaging system 118, using components described above with respect to FIG. 2. Accordingly, the method 400 is described by way of example with reference to the imaging system 118. However, it shall be appreciated that at least some of the operations of the method 400 may be deployed on various other hardware configurations or be performed by similar components residing elsewhere in the network environment 100. Therefore, the method 400 is not intended to be limited to the imaging system 118.

Initially, a user activates an application on their client device 106. Once the application is activated, the user selects a source image or captures an image using an image capture device (e.g., camera) of the client device 106 of an item that the user wants to use in the publication. In operation 402, the imaging system 118 accesses (e.g., receives, retrieves) the source image. In some embodiments, the source image is accessed via the user interface component 202 or the image processing component 204 from the client device 106 or a data storage (e.g., data storage 122).

In operation 404, the image processing component 204 pre-processes the source image. In example embodiments, the image processing component 204 first isolates the item or object in the source images. Once the item is isolated, the background is then be removed by the image processing component 204. The image processing component 204 can also crop, scale, and adjust contrast.

In operation 406, the image classification component 206 identifies an item category of the item in the source image. In example embodiments, the image classification component 206 comprises a trained classification model. The source image is applied to the classification model, which can identify at least an item category for the item or the item itself.

In operation 408, the mapping component 208 determines additional information (or mapping information) for the item. In some embodiments, the mapping component 208 performs a look up of the item category in a mapping database that comprises a mapping of each item category to additional information such as, for example, a relative size, a typical orientation, a natural environment(s), and/or an applicable lighting or lighting effect. The mapping database can also indicate one or more suggested backgrounds for the item category and/or a deviation parameter.

In an alternative embodiment, the mapping component 208 comprises or uses an LLM to determine the additional information. In this embodiment, a prompt is generated by the mapping component 208 based on the item category and any information the user may have provided with the source image (e.g., a proposed title). The prompt is then provided to the LLM (e.g., the external system 108 or internal generative system 216), which is prompted to identify the additional information.

In operation 410, the background component 210 suggests one or more backgrounds for the item. In some cases, the suggested backgrounds can be obtained from the mapping information identified by the mapping component 208. In other cases, the suggested backgrounds are determined based on the environment information obtained from the mapping component 208. In yet further cases, the suggested backgrounds are identified by a background selection model that is trained to identify backgrounds that are typically used for the item or item category or are used in publications that are selected the most by other users. If more than one background is suggested, the user can select the background to apply.

Once a suggested background is identified or selected, a guidance image can be generated in operation 412. In example embodiments, the image processing component 204 combines the source image with the background removed with the suggested background to generate the guidance image (e.g., positions the source image with the background removed over the suggested background to form a single image). In an alternative embodiment, the guidance image can include both the source image with the background removed and the suggested background separately (e.g., as two separate images).

In operation 414, the prompt component 212 generates a prompt and triggers image generation by the generative AI system using the prompt. The prompt component 212 can include the identification of the item or item category, the additional information obtained from the mapping component 208, and instructions to generate images that include a shadow using the provided information in the prompt. In some cases, the prompt the LLM used to identify the additional information and/or background generates the prompt that triggers generation of the images. The prompt along with the guidance image is then used to trigger the generative system to generate the images.

In operation 416, the user interface component 202 causes display of the generated images. In embodiments where the generative system is the external system 108, the imaging system 118 receives the generated images via the network 104 and triggers the user interface component 202 to display the generated images at the client device 106. Alternatively, if the generative system is the internal generative system 216, the generated images can be passed from the internal generative system 2116 to the user interface component 202. The user interface component 202 then causes display of any number of generated images on the client device 106.

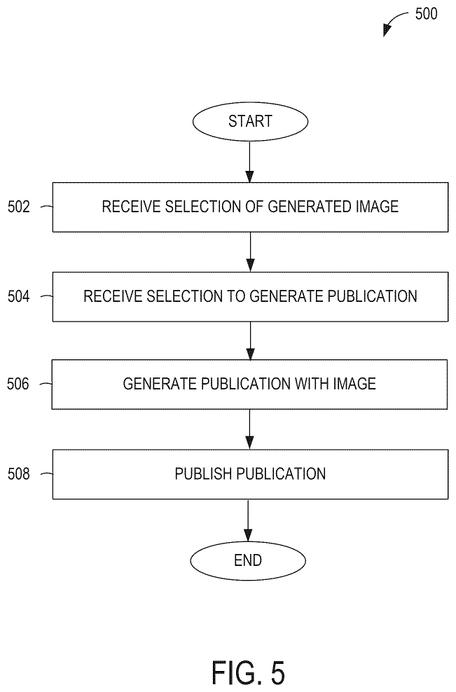

In operation 418, the imaging system 118 performs further processing. The operations of the further processing will be discussed in further detail in connection with FIG. 5-FIG. 7 below.

FIG. 5 is a flowchart illustrating operations of a method 500 for generating a publication using a generated image, according to example embodiments. Operations in the method 500 may be performed by the imaging system 118, using components described above with respect to FIG. 2. Accordingly, the method 500 is described by way of example with reference to the imaging system 118. However, it shall be appreciated that at least some of the operations of the method 500 may be deployed on various other hardware configurations or be performed by similar components residing elsewhere in the network environment 100. Therefore, the method 500 is not intended to be limited to the imaging system 118.

In operation 502, the user interface component 202 receives a selection of one of the generated images. In some cases, the selection causes the selected generated image to be displayed in a preview view such as shown in FIG. 3D.

In operation 504, the user interface component 202 receives a selection of an option to incorporate the selected generated image into a publication. The receipt of this selection triggers the publication system 116 to incorporate the selected image into the publication in operation 506. For example, an item listing can incorporate the selected generated image into a portion of the listing where images are shown. The user can edit the publication by including further information and/or incorporating additional generated images.

Once the publication is finalized, the publication system 116 publishes the publication in operation 508. In embodiments where the publication comprises an item listing, the publication can be published to an online marketplace. In embodiments where the publication comprises an article, the publication can be published to an appropriate website.

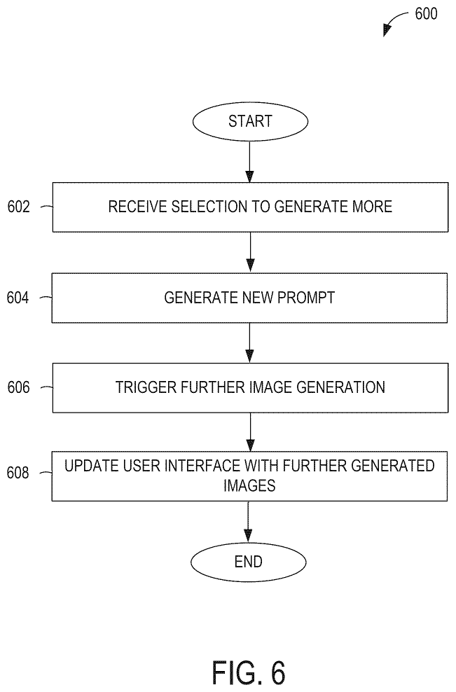

FIG. 6 is a flowchart illustrating operations of a method 600 for generating further images with natural backgrounds, according to example embodiments. Operations in the method 600 may be performed by the imaging system 118, using components described above with respect to FIG. 2. Accordingly, the method 600 is described by way of example with reference to the imaging system 118. However, it shall be appreciated that at least some of the operations of the method 600 may be deployed on various other hardware configurations or be performed by similar components residing elsewhere in the network environment 100. Therefore, the method 600 is not intended to be limited to the imaging system 118.

In operation 602, the user interface component 202 receives a selection of one of the generated images and a selection to generate more images. For example and referring to FIG. 3C, the user can select the generated image 306 and select the generate more icon shown at the bottom of the user interface 304.

The selection to generate more images triggers generation of a new prompt in operation 604. In example embodiments, the prompt component 212 generates the new prompt requesting more images based on the selected generated image being the new guidance image.

In operation 606, the imaging system 118 triggers generation of the further images. Accordingly, the prompt component 212 transmits the new prompt and the new guidance image to the generative AI system and receives the further generated images in response. Subsequently, in operation 608, the user interface component 202 updates the user interface with the further generated images.

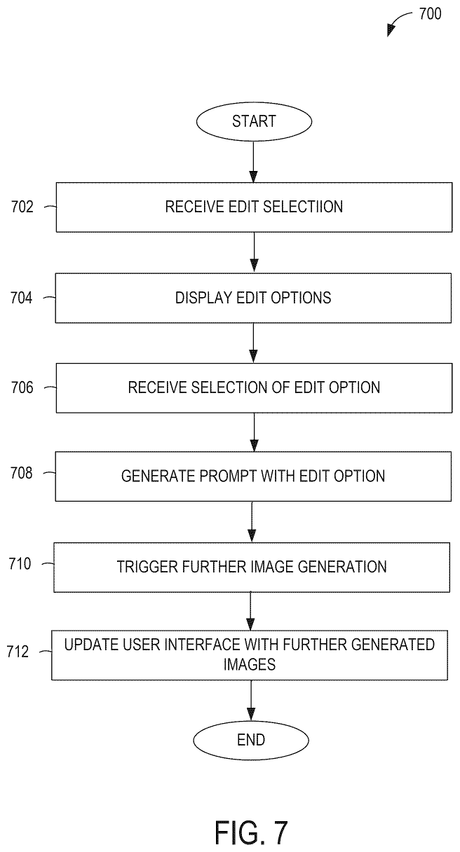

FIG. 7 is a flowchart illustrating operations of another method 700 for editing the generated images, according to example embodiments. Operations in the method 700 may be performed by the imaging system 118, using components described above with respect to FIG. 2. Accordingly, the method 700 is described by way of example with reference to the imaging system 118. However, it shall be appreciated that at least some of the operations of the method 700 may be deployed on various other hardware configurations or be performed by similar components residing elsewhere in the network environment 100. Therefore, the method 700 is not intended to be limited to the imaging system 118.

In operation 702, the user interface component 202 receives a selection to perform an edit operation. Depending on the current selected background, different edit options are determined by the edit component 214 and displayed in operation 704. For example, in embodiments where a studio background is currently selected, the edit options can include different background colors. In another example, if the currently selected background is a surface background, then the edit options can include different surface materials (e.g., wood, marble, fabric, glass, concrete). In a further example, if the currently selected background is an outdoor background, then the edit options can include different outdoor elements (e.g., forest, mountain, grass, city, snow, lake) and/or moods (e.g., midday, golden hour, overcast). In some cases, the edit options can also include adjusting a shadow that is applied (e.g., deepen shadow, lighten shadow).

In operation 706, the user interface component 202 receives a selection of one of the edit options. The selected edit option is then provided to the prompt component 212.

In operation 708, the prompt component 212 generates a further prompt based on the selected edit option. The further prompt can include the additional information previously obtained for the item category and instructions to generate images based on a new guidance image (e.g., one of the generated images) and the selected edit option.

In operation 710, the prompt component 212, triggers generation of further images based on the selected edit option. In example embodiments, the further prompt and the guidance image is transmitted to the generative AI system, which returns the further generated images.

In operation 712, the user interface component 202 updates the user interface with the further generated images.

It is noted that at any point in the process, the user can return to the user interface having the source image with the background removed and the suggested backgrounds (e.g., FIG. 3B). From there, the user can elect to change the suggested background.

FIG. 8 illustrates components of a machine 800, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 8 shows a diagrammatic representation of the machine 800 in the example form of a computer device (e.g., a computer) and within which instructions 824 (e.g., software, a program, an application, an applet, an app, or other executable code) for causing the machine 800 to perform any one or more of the methodologies discussed herein may be executed, in whole or in part.

For example, the instructions 824 may cause the machine 800 to execute the flow diagram of FIG. 4-FIG. 7. In one embodiment, the instructions 824 can transform the machine 800 into a particular machine (e.g., specially configured machine) programmed to carry out the described and illustrated functions in the manner described.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824 (sequentially or otherwise) that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more components described herein.

The machine 800 may further include a graphics display 810 (e.g., a plasma display panel (PDP), a light emitting diode (LED) display, a liquid crystal display (LCD), a projector, or a cathode ray tube (CRT), or any other display capable of displaying graphics or video). The machine 800 may also include an input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a sound card, an amplifier, a speaker, a headphone jack, or any suitable combination thereof), and a network interface device 820.

The storage unit 816 includes a machine-storage medium 822 (e.g., a tangible machine-storage medium) on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered as machine-storage media (e.g., tangible and non-transitory machine-storage media). The instructions 824 may be transmitted or received over a network 826 via the network interface device 820.

In some example embodiments, the machine 800 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 804, 806, and/or memory of the processor(s) 802) and/or storage unit 816 may store one or more sets of instructions and data structures (e.g., software) 824 embodying or utilized by any one or more of the methodologies or functions described herein. These instructions, when executed by processor(s) 802 cause various operations to implement the disclosed embodiments.

As used herein, the terms “machine-storage medium,” “device-storage medium,” “computer-storage medium” (referred to collectively as “machine-storage medium 822”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 822 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 822 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 824 may further be transmitted or received over a communications network 826 using a transmission medium via the network interface device 820 and utilizing any one of a number of well-known transfer protocols (e.g., TCP/IP). Examples of communication networks 826 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented components may be located in a single geographic location (e.g., within a home environment, an office environment, or a server farm). In other example embodiments, the one or more processors or processor-implemented components may be distributed across a number of geographic locations.

### EXAMPLES

Example 1 is a method for generating images having natural background and a shadow. The method comprises accessing a source image of an item; isolating, by an image processing component, the item by removing a background from the source image; identifying, by an image classification model, an item category of the item; based on the item category, identifying additional information regarding the item including a typical orientation of the item; generating a prompt that includes at least some of the additional information and instructions to generate images having a natural background; generating a guidance image that is a combination of the source image with the background removed and a suggested background; using the prompt and the guidance image, triggering an artificial intelligence (AI) model to generate one or more images of the item having the natural background, the natural background being generated based on the suggested background and comprising a shadow of the item; and causing presentation of the one or more generated images on a display of a client device.

In example 2, the subject matter of example 1 can optionally include determining a plurality of suggested backgrounds applicable to the item category; causing presentation of the plurality of suggested backgrounds on the display of the client device; and receiving a selection of the suggested background from the plurality of suggested backgrounds.

In example 3, the subject matter of any of examples 1-2 can optionally include wherein the plurality of suggested background comprises a plurality of suggested background categories.

In example 4, the subject matter of any of examples 1-3 can optionally include wherein the plurality of suggested backgrounds comprises an actual background for the item category.

In example 5, the subject matter of any of examples 1-4 can optionally include receiving an indication to edit the plurality of generated images; in response to receiving the indication, causing a user interface to be displayed on the client device that provides a plurality of edit options; receiving a selection of an edit option of the plurality of edit options; and triggering the AI model to generate additional images based on the selected edit option.

In example 6, the subject matter of any of examples 1-5 can optionally include wherein the edit options comprise changing a material, changing a shadow, changing a surrounding, changing a mood, or changing a background color.

In example 7, the subject matter of any of examples 1-6 can optionally include receiving an indication to generate additional images; and in response to receiving the indication, triggering the AI model to generate the additional images using a previously generated image as a new guidance image.

In example 8, the subject matter of any of examples 1-7 can optionally include wherein the determining the one or more suggested backgrounds is performed by a trained model, the trained model being trained on previously selected suggested backgrounds for the item category and feedback on use of the previously selected suggested backgrounds.

In example 9, the subject matter of any of examples 1-8 can optionally include receiving a selection of a generated image from the plurality of generated images; processing the selected generated image to isolate the shadow; and reusing the shadow for future images without having to trigger the AI model to generate the future images.

In example 10, the subject matter of any of examples 1-9 can optionally include wherein the additional information further comprises one or more of an angle of view, a lighting effect, an environment, a deviation parameter, a relative size, or one or more suggested backgrounds.

In example 11, the subject matter of any of examples 1-10 can optionally include wherein identifying the additional information comprises accessing a mapping database comprising mappings of item categories to the additional information.

In example 12, the subject matter of any of examples 1-11 can optionally include wherein identifying the additional information comprises generating a second prompt based on the item category; and using the second prompt, triggering an LLM to generate the additional information.

In example 13, the subject matter of any of examples 1-12 can optionally include wherein the second prompt includes a title associated with the item.

In example 14, the subject matter of any of examples 1-13 can optionally include receiving feedback associated with the plurality of generated images; and based on the feedback, fine-tuning a deviation parameter associated with the AI model.

Example 15 is a system for generating images having natural background and a shadow. The system comprises one or more processors and a memory storing instructions that, when executed by the one or more processors, cause the one or more processors to perform operations comprising accessing a source image of an item; isolating, by an image processing component, the item by removing a background from the source image; identifying, by an image classification model, an item category of the item; based on the item category, identifying additional information regarding the item including a typical orientation of the item; generating a prompt that includes at least some of the additional information and instructions to generate images having a natural background; generating a guidance image that is a combination of the source image with the background removed and a suggested background; using the prompt and guidance image, triggering an artificial intelligence (AI) model to generate one or more images of the item having the natural background, the natural background being generated based on the suggested background and comprising a shadow of the item; and causing presentation of the one or more generated images on a display of a client device.

In example 16, the subject matter of example 15 can optionally include wherein the operations further comprise determining a plurality of suggested backgrounds applicable to the item category; causing presentation of the plurality of suggested backgrounds on the display of the client device; and receiving a selection of the suggested background from the plurality of suggested backgrounds.

In example 17, the subject matter of any of examples 15-16 can optionally include wherein the operations further comprise receiving an indication to edit the plurality of generated images; in response to receiving the indication, causing a user interface to be displayed on the client device that provides a plurality of edit options; receiving a selection of an edit option of the plurality of edit options; and triggering the AI model to generate additional images based on the selected edit option.

In example 18, the subject matter of any of examples 15-17 can optionally include wherein the operations further comprise receiving a selection of a generated image from the plurality of generated images; processing the selected generated image to isolate the shadow; and reusing the shadow for future images without having to trigger the AI model to generate the future images.

In example 19, the subject matter of any of examples 15-18 can optionally include wherein identifying the additional information comprises accessing a mapping database comprising mappings of item categories to the additional information.

Example 20 is a computer-storage medium comprising instructions which, when executed by one or more processors of a machine, cause the machine to perform operations for generating images having natural background and a shadow. The operations comprise accessing a source image of an item; isolating, by an image processing component, the item by removing a background from the source image; identifying, by an image classification model, an item category of the item; based on the item category, identifying additional information regarding the item including a typical orientation of the item; generating a prompt that includes at least some of the additional information and instructions to generate images having a natural background; generating a guidance image that is a combination of the source image with the background removed and a suggested background; using the prompt and guidance image, triggering an artificial intelligence (AI) model to generate one or more images of the item having the natural background, the natural background being generated based on the suggested background and comprising a shadow of the item; and causing presentation of the one or more generated images on a display of a client device.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
accessing a source image of an item;
isolating, by an image processing component, the item by removing a background from the source image;
identifying, by an image classification model, an item category of the item;
based on the item category, identifying additional information regarding the item, the additional information including a typical orientation of the item;
generating a prompt that includes at least some of the additional information and instructions to generate images having a natural background;
generating a guidance image that is a combination of the source image with the background removed and a suggested background;
using the prompt and the guidance image, triggering an artificial intelligence (AI) model to generate one or more images of the item having the natural background, the natural background being generated based on the suggested background and comprising a shadow of the item; and
causing presentation of the one or more generated images on a display of a client device.

2. The method of claim 1, further comprising:
determining a plurality of suggested backgrounds applicable to the item category;
causing presentation of the plurality of suggested backgrounds on the display of the client device; and
receiving a selection of the suggested background from the plurality of suggested backgrounds.

3. The method of claim 2, wherein the plurality of suggested background comprises a plurality of suggested background categories.

4. The method of claim 2, wherein the plurality of suggested backgrounds comprises an actual background for the item category.

5. The method of claim 1, further comprising:
receiving an indication to edit the plurality of generated images;
in response to receiving the indication, causing a user interface to be displayed on the device that provides a plurality of edit options;
receiving a selection of an edit option of the plurality of edit options; and
triggering the AI model to generate additional images based on the selected edit option.

6. The method of claim 5, wherein the edit options comprise changing a material, changing a shadow, changing a surrounding, changing a mood, or changing a background color.

7. The method of claim 1, further comprising:
receiving an indication to generate additional generated images; and
in response to receiving the indication, triggering the AI model to generate the additional generated images using a previously generated image as a new guidance image.

8. The method of claim 1, wherein the determining the one or more suggested backgrounds is performed by a trained model, the trained model being trained on previously selected suggested backgrounds for the item category and feedback on use of the previously selected suggested backgrounds.

9. The method of claim 1, further comprising:
receiving a selection of a generated image from the plurality of generated images;
processing the selected generated image to isolate the shadow; and
reusing the shadow for future images without having to trigger the AI model to generate the future images.

10. The method of claim 1, wherein the additional information further comprises one or more of an angle of view, a lighting effect, an environment, a deviation parameter, a relative size, or one or more suggested backgrounds.

11. The method of claim 1, wherein identifying the additional information comprises accessing a mapping database comprising mappings of item categories to the additional information.

12. The method of claim 1, wherein identifying the additional information comprises:
generating a second prompt based on the item category; and
using the second prompt, triggering an LLM to generate the additional information.

13. The method of claim 12, wherein the second prompt includes a title associated with the item.

14. The method of claim 1, further comprising:
receiving feedback associated with the plurality of generated images; and
based on the feedback, fine-tuning a deviation parameter associated with the AI model.

15. A system comprising:
one or more processors; and
a memory storing instructions that, when executed by the one or more processors, cause the one or more processors to perform operations comprising:
accessing a source image of an item;
isolating, by an image processing component, the item by removing a background from the source image;
identifying, by an image classification model, an item category of the item;
based on the item category, identifying additional information regarding the item, the additional information including a typical orientation of the item;
generating a prompt that includes at least some of the additional information and instructions to generate images having a natural background;
generating a guidance image that is a combination of the source image with the background removed and a suggested background;
using the prompt and the guidance image, triggering an artificial intelligence (AI) model to generate one or more images of the item with a natural background, the natural background being generated based on the suggested background and comprising a shadow of the item; and
causing presentation of the one or more generated images on a display of client device.

16. The system of claim 15, wherein the operations further comprise:
determining a plurality of suggested backgrounds applicable to the item category;
causing presentation of the plurality of suggested backgrounds on the display of the client device; and
receiving a selection of the suggested background from the plurality of suggested backgrounds.

17. The system of claim 15, wherein the operations further comprise:
receiving an indication to edit the plurality of generated images;
in response to receiving the indication, causing a user interface to be displayed on the device that provides a plurality of edit options;
receiving a selection of an edit option of the plurality of edit options; and
triggering the AI model to generate additional images based on the selected edit option.

18. The system of claim 15, wherein the operations further comprise:
receiving a selection of a generated image from the plurality of generated images;
processing the selected generated image to isolate the shadow; and
reusing the shadow for future images without having to trigger the AI model to generate the future images.

19. The system of claim 15, wherein identifying the additional information comprises accessing a mapping database comprising mappings of item categories to the additional information.

20. A machine-storage medium comprising instructions which, when executed by one or more processors of a machine, cause the machine to perform operations comprising:
accessing a source image of an item;
isolating, by an image processing component, the item by removing a background from the source image;
identifying, by an image classification model, an item category of the item;
based on the item category, identifying additional information regarding the item, the additional information including a typical orientation of the item;
generating a prompt that includes at least some of the additional information and instructions to generate images having a natural background;
generating a guidance image that is a combination of the source image with the background removed and a suggested background;
using the prompt and the guidance image, triggering an artificial intelligence (AI) model to generate one or more images of the item having a natural background, the natural background being generated based on the suggested background and comprising a shadow of the item; and
causing presentation of the one or more generated images on a display of a client device.
